(19) United States
(12) Patent Application Publication
(10) Pub. No.: US 2018/0039156 A1
(43) Pub. Date: Feb. 8, 2018

(54) Camera Module and Auto-Focus Adjustment Method Using Same

(71) Applicant: LG INNOTEK CO., LTD., Seoul (KR)

(72) Inventors: Young Seop Moon, Seoul (KR); Min Kim, Seoul (KR)

(21) Appl. No.: 15/553,877

(22) PCT Filed: Feb. 26, 2016
(86) PCT No.: PCT/KR2016/001921

§ 371 Date: Aug. 25, 2017

(30) Foreign Application Priority Data
Feb. 26, 2015 (KR) 10-2015-0026974
Feb. 26, 2015 (KR) 10-2015-0027226

(51) Int. Cl. G03B 3/10; H04N 5/232; G02B 7/04

(52) U.S. Cl. CPC G03B 3/10; G02B 7/04; H04N 5/23212; H04N 5/23296

(57) ABSTRACT

According to an embodiment, disclosed are a camera module and an auto-focus adjustment method using the same, the camera module comprising: an optical unit comprising at least one lens; an image sensor unit for converting an optical signal obtained from the optical unit into image information; an image information processing unit for extracting focusing image information from the converted image information; a memory unit for storing an AF code value; a control unit for detecting the AF code value corresponding to the focusing image information extracted at the image information processing unit and generating a driving signal to move the optical unit; and a driving unit for adjusting the position of the at least one lens according to the driving signal, wherein the AF code value is updated with the AF code value of the last focus image so that the focus image may be obtained quickly, and it is possible to perform accurate focusing and obtain a high quality image even if the number of uses increases or the usage environment changes.

### TECHNICAL FIELD

Embodiments relate to a camera module and an auto-focus adjustment method using the same.

### BACKGROUND ART

With the increased demand for high-quality image acquisition technology in a camera, an auto focus (AF) system has been increasingly applied to cameras for mobile phones or small-sized mobile devices as well as digital cameras and interchangeable lens cameras.

A phase difference detection type AF system or a contrast detection type AF system is mainly used as the AF system.

In the contrast detection type AF system, high-frequency data are extracted from image data acquired by an image sensor, and AF control is performed to maximize the high-frequency data. An additional sensor or optical system for contrast AF is not needed. Consequently, the AF system may be configured at relatively low cost, and accurate focusing may be performed. However, the contrast detection type AF system takes a relatively long time to perform focus adjustment, since the contrast detection type AF system is of a micro focus adjustment type.

In the phase difference detection type AF system, light incident through a pick-up lens is pupil-divided into a pair of images, and a phase difference, which is an interval between the images, is detected to set the position of the pick-up lens, thereby detecting focus.

In the phase difference detection type AF system, a phase difference detection AF sensor may be provided separately from the pick-up lens, or phase difference detection pixels may be arranged in an image sensor.

The phase difference detection type AF system is less precise than the contrast detection type AF system but performs focus adjustment more rapidly than the contrast detection type AF system.

Meanwhile, in order to adjust the focus of a camera, it is necessary to change the position of an optical unit included in the camera. As the pick-up device is continuously used, the number of movements of the optical unit increases, with the result that the mechanism of the camera for moving the optical unit may become worn. As the number of focus adjustments increases, therefore, the position change sensitivity of the optical unit, which is moved to acquire an accurately focused image, may be deteriorated.

### DISCLOSURE

### Technical Problem

Embodiments provide a camera module that acquires a focused image using a phase difference focus adjustment method and a contrast focus adjustment method and updates data extracted from a final focused image acquired through focus adjustment in a memory unit, thereby acquiring a high-quality image even when the environment in which the camera module is used is changed, and an auto-focus adjustment method using the same.

In addition, embodiments provide a camera module that is capable of preventing deterioration of an image due to hand shaking through the use of a calculation method based on shield pixel values.

### Technical Solution

In one embodiment, a camera module includes an optical unit comprising at least one lens, an image sensor unit for converting an optical signal acquired by the optical unit into image information, an image information processing unit for extracting focus adjustment image information from the converted image information, a memory unit for storing an auto focus (AF) code value, a controller for retrieving the AF code value corresponding to the focus adjustment image information extracted by the image information processing unit and generating a driving signal for moving the optical unit, and a driving unit for adjusting the position of the at least one lens according to the driving signal, wherein the AF code value is updated to an AF code value of a final focused image.

The focus adjustment image information may include a phase difference value of the converted image information.

The driving unit may include an actuator module for moving the optical unit in an optical-axis direction.

The controller may include a first AF controller for controlling the optical unit using a phase difference focus adjustment method and a second AF controller for controlling the optical unit using a contrast focus adjustment method.

The image sensor unit may include an optical filter layer including a plurality of pick-up pixels, a shield mask layer including a first pixel group having a shield region deviated to one side thereof and a second pixel group having a shield region deviated to the other side thereof, and a photodiode layer for converting the optical signal that has passed through the optical filter layer and the shield mask layer into an electrical signal.

Each of the pick-up pixels may be made up of any one selected from among red (R), green (G), and blue (B) pixels, and the optical filter layer may be configured such that the pick-up pixels are arranged so as to neighbor each other in the form of a lattice.

The first pixel group and the second pixel group may have openings, through which light is incident, and shield regions, by which light is blocked.

The shield region of the first pixel group and the shield region of the second pixel group may be symmetric with respect to a vertical line or a horizontal line passing through the center of the pixel.

The image sensor unit may include an optical filter layer comprising a plurality of pick-up pixels and a plurality of phase difference detection pixels, and a photodiode layer for converting an optical signal that has passed through the optical filter layer into an electrical signal.

The memory unit may be an electrically erasable programmable read-only memory (EEPROM) or a flash memory.

In another embodiment, an auto-focus adjustment method includes acquiring optical information, converting the acquired optical information into an electrical signal, calculating a phase difference value from the electrical signal, extracting an AF code value corresponding to the phase difference value, determining whether the difference between the extracted AF code value and a reference AF code value is equal to or less than a critical value, moving at least one lens to a focal distance position using at least one selected from between a phase difference auto-focus adjustment method and a contrast auto-focus adjustment method based on the extracted AF code value, and updating a final AF code value at the focal distance position in the memory unit.

Upon determining that the difference between the extracted AF code value and the reference AF code value is equal to or less than the critical value, the step of moving the at least one lens to the focal distance position may include performing micro focal distance adjustment using the contrast auto-focus adjustment method.

Upon determining that the difference between the extracted AF code value and the reference AF code value is greater than the critical value, the step of adjusting the at least one lens to the focal distance position may include moving the optical unit to a first focal distance corresponding to the extracted AF code value using the phase difference auto-focus adjustment method, and performing micro focal distance adjustment from the first focal distance to a second focal distance using the contrast auto-focus adjustment method.

In a further embodiment, a camera module having an image stabilization function includes an image sensor unit, an x/y-axis actuator for moving the image sensor unit in an x-axis direction and a y-axis direction, a z-axis actuator for moving the image sensor unit in a z-axis direction, and a driving unit for driving the x/y-axis actuator and the z-axis actuator, wherein the driving unit drives the x/y-axis actuator and the z-axis actuator based on the value of a left-shield pixel and the value of a right-shield pixel.

Normal pixels and shield pixels may be alternately arranged in rows of a frame, and left-shield pixels and right-shield pixels may be alternately arranged in the rows in which the shield pixels are arranged.

The driving unit may drive the x/y-axis actuator using values of a predetermined number of normal pixels located around each left-shield pixel and each right-shield pixel together.

The driving unit may include a calculation unit for calculating a difference value based on x/y-axis movement and a difference value based on z-axis movement using values of the left-shield pixels and values of the right-shield pixels, a lookup table for storing a movement value for moving the image sensor unit based on each difference value calculated by the calculation unit as a digital value, a digital/analog conversion unit for converting the digital value into an analog signal, and a driver integrated circuit (IC) for driving the x/y-axis actuator and the z-axis actuator according to the analog signal to move the image sensor unit.

The driving unit may drive the x/y-axis actuator using the difference between the left-shield pixel values sensed in the previous frame and the current frame and the difference between the right-shield pixel values of the previous frame and the current frame.

The driving unit may drive the x/y-axis actuator with reference to a lookup table. The lookup table may store a value for driving the x/y-axis actuator corresponding to the difference between the left-shield pixel values sensed in the previous frame and the current frame and the difference between the right-shield pixel values of the previous frame and the current frame.

The driving unit may drive the z-axis actuator based on a phase difference between the left-shield pixel values and the right-shield pixel values.

### Advantageous Effects

In a camera module and an auto-focus adjustment method using the same according to embodiments, a phase difference detection type focus adjustment method and a contrast auto-focus adjustment method are used simultaneously, and an AF code value for the position of a lens in a final focused state is continuously updated and stored. Consequently, it is possible to calculated a focus value coinciding with changes in the properties of parts and in the environment in which the camera module is used, thereby acquiring a high-resolution image.

In addition, it is possible to sense hand shaking without using a physical sensor, such as a gyro sensor or a hall sensor, thereby performing an image stabilization function. Consequently, the structure of the camera module is simplified, manufacturing costs of the camera module are reduced, and the size and weight of the camera module are reduced.

Furthermore, the possibility of saturation occurring due to external light is reduced due to the shield regions of shield pixels, whereby stable operation of the camera module is achieved.

### DESCRIPTION OF DRAWINGS

FIG. 1 is a block diagram of a camera module according to an embodiment;

FIG. 2 is a sectional view of the camera module according to the embodiment;

FIG. 3a is a view showing phase difference detection pixels included in an image sensor unit according to an embodiment;

FIG. 3b is a view showing an embodiment of image information generated by the phase difference detection pixels;

FIGS. 4a and 4b are views showing the relationship between phase difference values and auto focus (AF) code values;

FIG. 5 is a flowchart showing an auto-focus adjustment method according to an embodiment;

FIG. 6 is a view showing a camera module having an image stabilization function according to another embodiment;

FIG. 7 is a view showing a left-shield pixel and a right-shield pixel;

FIG. 8 is a view showing an example in which x/y-axis control is performed using shield pixel values of the previous frame and the current frame;

FIG. 9 is a view showing an example in which z-axis control is performed using the phase difference between a left-shield pixel value and a right-shield pixel value; and

FIG. 10 is a view showing a camera module according to an embodiment.

### BEST MODE

Reference will now be made in detail to preferred embodiments, examples of which are illustrated in the accompanying drawings.

It will be understood that when an element is referred to as being “on” or “under” another element, it can be directly on/under the element, or one or more intervening elements may also be present. In addition, when an element is referred to as being “on” or “under,” “under the element” as well as “on the element” may be included based on the element.

In addition, relational terms, such as “first,” “second,” “on/upper part/above” and “under/lower part/below,” are used only to distinguish between one subject or element and another subject and element, without necessarily requiring or involving any physical or logical relationship or sequence between such subjects or elements.

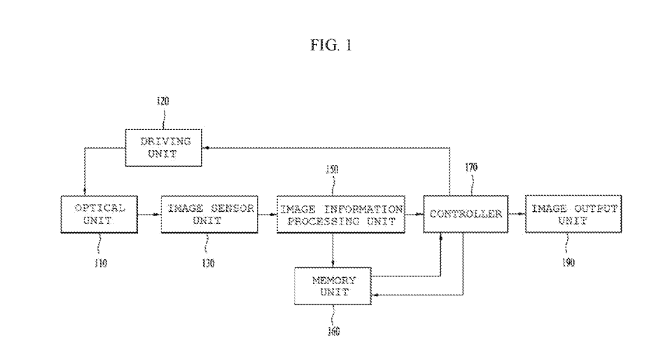

FIG. 1 is a block diagram showing the construction of a camera module according to an embodiment.

The camera module according to the embodiment may include an optical unit 110, an image sensor unit 130, an image information processing unit 150, a memory unit 160, and a controller 170.

In addition, the camera module according to the embodiment may further include a driving unit 120 for driving the optical unit 110.

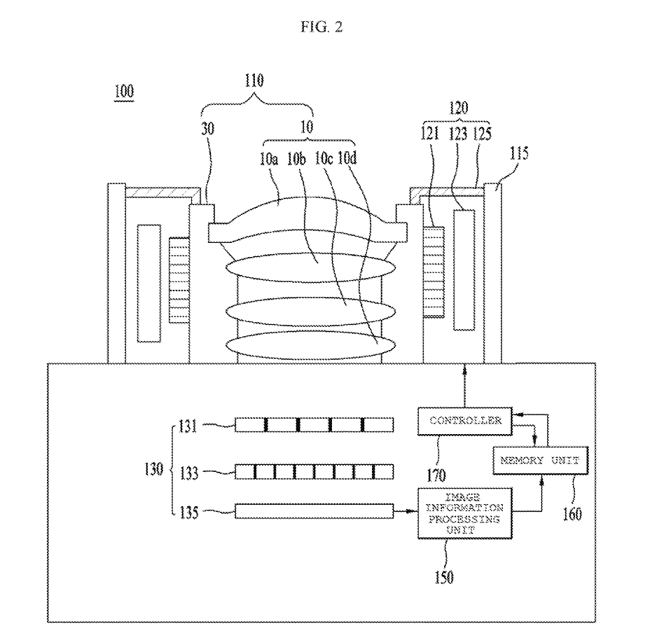

FIG. 2 is a sectional view schematically showing the camera module according to the embodiment.

In the camera module shown in FIGS. 1 and 2, the optical unit 110 may receive light incident from outside and output the received light to the image sensor unit 130 in order to acquire an image of a subject.

The optical unit 110 may include at least one lens. An optical signal acquired by the at least one lens of the optical unit may be transmitted to the image sensor unit 130.

Referring to FIG. 2, the optical unit 110 included in the embodiment may include a lens unit 10 constituted by a plurality of stacked lenses 10a, 10b, 10c, and 10d and a bobbin 30, in which at least one lens is located such that the position of the lens is capable of being adjusted.

In addition, referring to FIG. 2, the lenses 10a to 10d are shown as being directly fixed to the bobbin 30. Alternatively, a lens unit 10 constituted by at least one lens may be fixed to an additional lens barrel (not shown), and the lens barrel (not shown) may be provided in the bobbin 30.

The at least one lens 10 fixed to the bobbin 30 may be adjusted such that the position thereof is changed in the optical-axis direction, i.e. in the upward-downward direction in the figure, to adjust the focus of an image formed by the optical signal acquired by the optical unit 110.

The at least one lens 10a to 10d included in the optical unit 110 may be a focus lens or a zoom lens. In addition, at least one of the lenses 10a to 10d included in the optical unit 110 may condense light to the image sensor unit 130.

The at least one lens 10a to 10d may receive a large amount of light from a point of a subject and refract incident light to thus collect the received light to a point.

The light collected to the point may form an image. In the case in which the light is collected to the point by the image sensor unit 130 and forms an image, the subject is regarded as being located at the focal distance of the lens. In contrast, in the case in which the image acquired by the image sensor unit 130 includes two images having a phase difference therebetween, the acquired image is an unfocused image. In order to locate the lens at the focal distance, therefore, it is necessary to perform focus adjustment for moving the position of the optical unit.

In addition, four lenses 10a to 10d are shown in the figure. However, the number of lenses constituting the optical unit 110 is not limited thereto. A single lens or a plurality of lenses may be disposed in the optical unit 110.

The at least one lens 10a to 10d may be sequentially stacked. A spacer (not shown) may be disposed between the at least one lens 10a to 10d. The spacer may allow the lenses 10a to 10d to be spaced apart from each other to maintain the distance between the lenses 10a to 10d.

The position of the at least one lens 10a to 10d included in the optical unit 110 may be adjusted by the driving unit 120. That is, the position of the optical unit 110 may be changed by the driving unit 120.

The driving unit 120 may include an actuator module for adjusting the position of the at least one lens included in the optical unit 110. In the camera module, the actuator module may perform an auto-focusing (AF) function.

Referring to FIG. 2, the actuator module may include a voice coil motor (VCM) 121, a magnet 123 configured to interact with the VCM, and an elastic member 125. The elastic member 125 may be connected to the bobbin 30, to which the lenses are fixed.

For example, the elastic member 125 may connect a housing 115, disposed so as to surround the optical unit 110, to the optical unit 110. The elastic member 125 may be a spring-type member or a ball-type member.

The elastic member 125 may extend or contract as the position of the optical unit 110 is changed. That is, the elastic member 125 may perform an elastic motion. Meanwhile, when the number of focus adjustments increases as the number of uses of the camera module increases, the elastic member connected to the optical unit 110 is increasingly used. As a result, the elastic value of the elastic member may be different from the initial elastic value of the elastic member when the elastic member is mounted to the pick-up device.

The image sensor unit 130 may convert an optical signal input from the optical unit 110 to generate image information. The image information generated by the image sensor unit 130 may be image information of a subject. For example, image information generated when a captured image of a subject is acquired may include image information of the subject and focus adjustment image information used for focus adjustment of the captured image of the subject.

The image sensor unit 130 may receive the optical information of a subject incident through the optical unit 110 and photoelectrically convert the received optical information into an electrical signal. The image sensor unit 130 may be a charge-coupled device (CCD) sensor or a complementary metal-oxide semiconductor (CMOS) sensor.

In the camera module 100 according to the embodiment shown in FIG. 2, the image sensor unit 130 may include an optical filter layer 133 including a plurality of pick-up pixels, a shield mask layer 131 including pixel groups having shield regions, and a photodiode layer 135 for converting an optical signal that has passed through the optical filter layer and the shield mask layer into an electrical signal.

The optical filter layer 133 may include a plurality of pick-up pixels. The pick-up pixels may be image pixels for generating an image of a subject. In addition, the pick-up pixels of the optical filter layer may be color pixels.

That is, each of the pick-up pixels may be any one selected from among red (R), green (G), and blue (B) pixels. The optical filter layer 133 may be configured such that the pick-up pixels are arranged so as to neighbor each other in the form of a lattice.

In order to acquired image information that is used for focus adjustment using a phase difference auto-focus adjustment method from the optical signal input from the optical unit 110, the shield mask layer 131 may include a first pixel group having a shield region deviated to one side thereof and a second pixel group having a shield region deviated to the other side thereof.

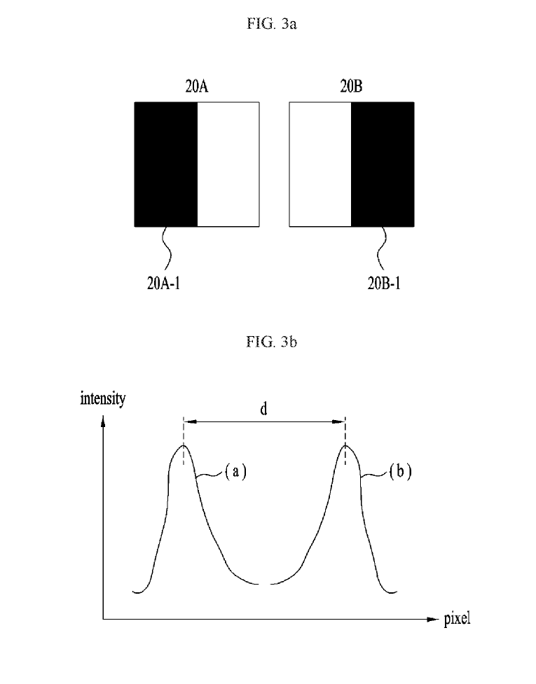

FIG. 3a is a view showing an embodiment of a first pixel group 20A and a second pixel group 20B included in the shield mask layer.

The first pixel group 20A and the second pixel group 20B may be phase difference detection pixels.

In addition, a shield region 20A-1 of the first pixel group and a shield region 20B-1 of the second pixel group may be symmetric with respect to a vertical line or a horizontal line passing through the center of the pixel.

The shield mask layer 131 may be realized as a metal mask. The first pixel group and the second pixel group of the shield mask layer 131 may have openings, through which light is incident, and shield regions, by which light is blocked.

In the case in which the optical unit 110 is not located at the focal distance when an image of a subject is captured, an optical signal input through the shield mask layer of the image sensor unit may generate two pieces of image information.

Meanwhile, the two images may be images that have passed through the shield mask layer 131 of the image sensor unit. That is, the two images may be images acquired from the optical signal of the subject that have passed through the symmetric shield regions of the shield mask layer, and may be images acquired by pupil division of the subject.

FIG. 3b is a view showing an embodiment of image information that has passed through the shield mask layer of the image sensor unit.

For example, in FIG. 3b, (a) may be the image information of an optical signal that has passed through the first pixel group 20A of FIG. 3a, and (b) may be the image information of an optical signal that has passed through the second pixel group 20B of FIG. 3b.

Referring to FIG. 3b, a pixel difference d, which is the distance between two points having the same intensity, may be a phase difference value.

That is, the phase difference value may be extracted from an unfocused image acquired by the optical unit 110 when the optical unit 110 is not located at the focal distance from a subject.

For example, when an image of the subject captured by the optical unit 110 is divided into a pair of phase difference detection images by the image sensor unit 130, the phase difference value may be the phase difference between two simultaneously acquired images of the same subject.

Meanwhile, although not shown in the figure, in another embodiment of the image sensor unit, the optical filter layer may include a plurality of pick-up pixels and a plurality of phase difference detection pixels. That is, an image sensor unit according to an embodiment may include an optical filter layer including a plurality of pick-up pixels and a plurality of phase difference detection pixels and a photodiode layer for converting an optical signal that has passed through the optical filter layer into an electrical signal.

Image information generated from the electrical signal converted by the image sensor unit 130 may include image information acquired by processing an optical signal that has passed through the pick-up pixels and information about the phase difference value extracted from image information acquired by processing an optical signal that has passed through the phase difference detection pixels of the mask layer.

The image information generated by the image sensor unit 130 may be transmitted to the image information processing unit 150.

For example, the image information processing unit 150 may generate image information of the captured image from the electrical signal of the pick-up pixels received from the image sensor unit 130, and may calculate and extract focus adjustment image information based on the electrical signal of the phase difference detection pixels of the optical filter layer.

That is, the image information processing unit 150 may extract focus adjustment image information for adjusting the focus of the captured image from the image information received from the image sensor unit 130.

The focus adjustment image information may be a phase difference value extracted from an unfocused image acquired by the optical unit 110 when the optical unit 110 is not located at the focal distance from the subject.

The image information processing unit 150 may generate image information from the electrical signal received from the image sensor unit 130, and may transmit the generated information to an image output unit 190, which outputs the information as an image.

In addition, the focus adjustment image information extracted by the image information processing unit 150 may be transmitted to the controller 170.

For example, the phase difference value, which is the focus adjustment image information calculated and extracted by the image information processing unit 150, may be transmitted to the controller 170, and the amount of movement of the optical unit 110 corresponding to the extracted phase difference value may be extracted from data values stored in the memory unit 160 and may then be transmitted to the controller 170.

The controller 170 may generate a driving signal for moving the optical unit 110.

The generated driving signal may be a data value stored in the memory unit 160 corresponding to the focus adjustment image information received from the image information processing unit 150, and may be a signal indicating the movement distance necessary to adjust the optical unit 110 to the focus position according to an auto focus (AF) code value stored in the memory unit 160.

For example, the driving signal generated by the controller 170 may be transmitted to the driving unit 120, and the driving unit 120 may move the optical unit 110 according to the received driving signal. That is, the position of at least one lens included in the optical unit 110 may be adjusted according to the driving signal, thereby adjusting the focus of the image information acquired by the optical unit 110.

In addition, the controller 170 may include a first AF controller for controlling the optical unit 110 using a phase difference focus adjustment method and a second AF controller for controlling the optical unit using a contrast focus adjustment method.

In the camera module according to the embodiment, the focus of the captured image may be adjusted using at least one selected from between the phase difference auto-focus adjustment method, in which control is performed by the first AF controller, and the contrast auto-focus adjustment method, in which control is performed by the second AF controller.

That is, the above two auto-focus adjustment methods may be used simultaneously, or at least one of the auto-focus adjustment methods may be used. A driving signal to be transmitted to the driving unit 120 may be generated by at least one selected from between the first AF controller and the second AF controller.

Meanwhile, the camera module according to the embodiment may include a memory unit 160 for storing auto focusing (AF) code values that are used for focus adjustment.

The memory unit 160 may store reference phase difference values, which are focus adjustment image information, and auto focus (AF) code values matched therewith in the form of a lookup table.

For example, the AF code values may be code values indicating the positions of the optical unit based on the reference phase difference values. In addition, the AF code values may be data values indicating the amount of movement of the optical unit 110 necessary to acquire a focused image.

That is, in the case in which an image acquired by the optical unit 110 is an unfocused image, the image information processing unit 150 may extract a phase difference value from the unfocused image.

Next, an AF code value corresponding to the extracted phase difference value may be retrieved from the memory unit 160, the controller 170 may generate a driving signal based on the AF code value retrieved from the memory unit 160, and the position of the optical unit 110 may be adjusted according to the generated driving signal, whereby a focused image may be acquired.

In the camera module according to the embodiment, the AF code values stored in the memory unit 160 may be updated.

That is, an AF code value stored in the memory unit may be updated to an AF code value changed as a final focused image is acquired through auto-focus adjustment performed by the pick-up device.

For example, the updated AF code value may be an AF code value of a final focused image acquired by adjusting the focus of an image, acquired by the optical unit, using the phase difference auto-focus adjustment method and the contrast auto-focus adjustment method.

The updated AF code value may be an AF code value in the case in which the AF code value at one point corresponding to the focus position, i.e. the phase difference, is 0. However, the disclosure is not limited thereto. All of the AF code values stored in the memory unit may be updated at a predetermined ratio.

That is, variation in the AF code value in the case in which the reference phase difference value is 0 may be applied to all of the AF code values stored in the memory unit such that new AF code values can be stored in the memory unit.

The memory unit 160 may be an electrically erasable programmable read-only memory (EEPROM) or a flash memory. That is, data values stored in the memory unit 160 may be newly updated and stored.

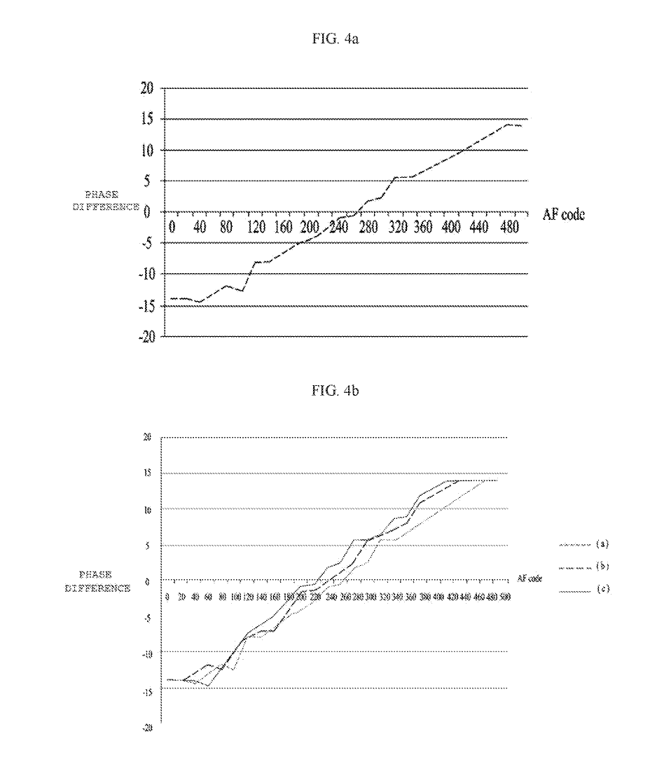

FIGS. 4a and 4b are views showing the relationship between phase difference values and AF code values.

In FIGS. 4a and 4b, the X axis may indicate AF code values, and the Y axis may indicate phase difference values. The graphs of FIGS. 4a and 4b show phase difference values and AF code values corresponding thereto.

FIG. 4a may show the relationship between phase difference values and AF code values when the camera module is initially used. That is, the AF code value of a relevant point may be found in the graph from the phase difference value calculated and extracted by the image information processing unit 150, and the controller may calculate the difference between the found AF code value and an AF code value in the case in which the phase difference value is 0 and generate a driving signal for moving the optical unit based on a value corresponding to the difference between the AF code values.

The driving signal generated by the controller may be transmitted to the driving unit, and the driving unit may move the optical unit according to the received driving signal to acquire a focused image.

FIG. 4b is a view showing the change of the AF code values based on the number of image acquisitions through auto-focus adjustment.

Referring to FIG. 4b, graph (a) shows the relationship between phase difference values and AF code values when the camera module is initially used, graph (b) shows the relationship between phase difference values and AF code values when the pick-up device is used over 5000 times, and graph (c) shows the relationship between phase difference values and AF code values when the camera module is used over 10000 times.

As shown in FIG. 4b, it can be seen that the deviation between the phase difference values and AF code values increases as the number of images captured by the camera module increases.

Since the AF code values initially stored in the memory unit of the camera module are based on the initial elastic value of the elastic member included in the driving unit, the elastic value of the elastic member may be changed as the number of focus adjustments in the camera module increases. As a result, the optical unit may not be moved to an accurate focus position if the initially stored AF code values are used.

Meanwhile, in the camera module according to the embodiment, the position of the optical unit may be sensed from a focused image acquired through auto-focus adjustment, and an AF code value may be calculated inversely therefrom such that the AF code value is updated as a new AF code value and stored in the memory unit.

That is, in the camera module according to the embodiment, the AF code value stored in the memory unit may be updated as an AF code value of a final focused image every time such that, even in the case in which the physical properties of the elastic member are changed depending on the number of uses, the optical unit is moved based on the updated AF code value, whereby it is possible to acquire an accurately focused image.

In the camera module according to the embodiment shown in FIGS. 1 and 2, focus adjustment image information may be extracted from an electrical signal converted by the image sensor unit 130, and focus adjustment may be performed from the extracted focus adjustment image information using at least one selected from between the phase difference auto-focus adjustment method and the contrast auto-focus adjustment method, whereby it is possible to acquire a final focused image.

In addition, a new AF code value may be extracted from the position of the optical unit when the final focused image is acquired, and the extracted AF code value may be continuously updated as a new data value, whereby it is possible to acquire a high-quality image through accurate auto-focus adjustment irrespective of the number of uses of the camera module and the environment in which the camera module is used.

Another embodiment may relate to an auto-focus adjustment method using the camera module according to the embodiment described with reference to FIGS. 1 and 2.

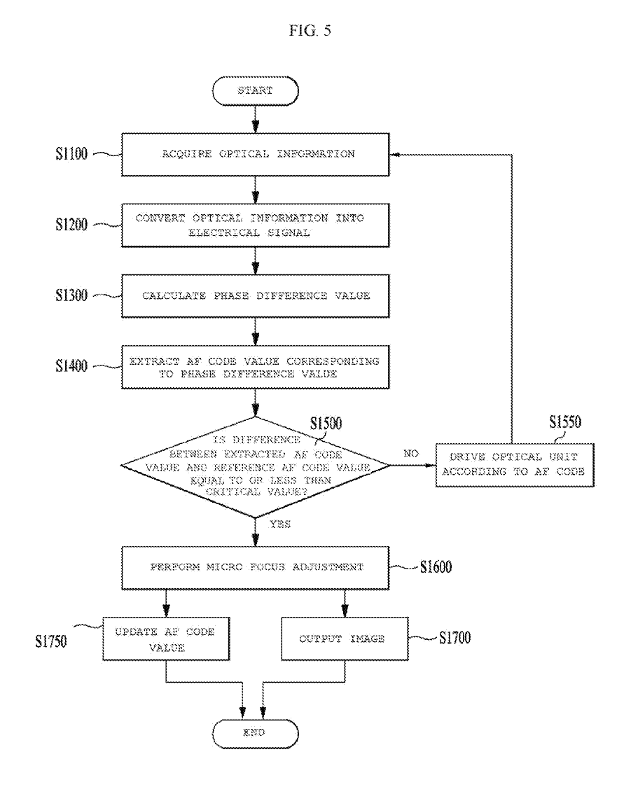

FIG. 5 is a flowchart showing an auto-focus adjustment method according to an embodiment.

Referring to FIG. 5, the auto-focus adjustment method according to the embodiment using the camera module according to the embodiment described above may include a step (S1100) of acquiring optical information, a step (S1200) of converting the acquired optical information into an electrical signal, a step (S1300) of calculating a phase difference value from the electrical signal, a step (S1400) of extracting an AF code value corresponding to the phase difference value, a step (S1500) of determining whether the difference between the extracted AF code value and a reference AF code value is equal to or less than a critical value, and a step of adjusting at least one lens to a focal distance position using at least one selected from between a phase difference auto-focus adjustment method and a contrast auto-focus adjustment method based on the AF code value.

The step of adjusting the at least one lens to the focal distance position may include a step (S1600) of performing micro focus adjustment using the contrast auto-focus adjustment method.

The step (S1600) of performing the micro focus adjustment may be a step of adjusting the at least one lens of the optical unit to the focal distance position. When the micro adjustment of the at least one lens is performed, a newly captured image that is in focus may be acquired from the optical unit.

In the auto-focus adjustment method according to the embodiment, a step (S1700) of outputting the captured image may be included after the step (S1600) of performing the micro focus adjustment.

In addition, a step (S1750) of updating a final AF code value of the captured image in the memory unit may be included after the step (S1600) of performing the micro focus adjustment.

In the auto-focus adjustment method according to the embodiment, the step (S1500) of determining whether the difference between the extracted AF code value and the reference AF code value is equal to or less than the critical value may be a step of determining whether a deviation of the AF code value for moving the optical unit to the focal distance position is equal to or less than a critical value.

That is, the extracted AF code value may be an AF code value retrieved from the memory unit based on the difference value of the captured image, the reference AF code value may be an AF code value corresponding to the position at which the difference value is 0, and the critical value may be a deviation range of the AF code value that must be satisfied in order to perform micro focus adjustment.

For example, the step (S1500) of determining whether the difference between the extracted AF code value and the reference AF code value is equal to or less than the critical value may be a step of determining whether the absolute value of the difference between a and b is equal to or less than c on the assumption that the extracted AF code value is a, the reference AF code value is b, and the critical value is c.

In this case, the AF code value corresponding to the phase difference value of the captured image extracted by the image information processing unit of the camera module according to the embodiment may be a, and the reference AF code value at the focus position at which the phase difference value is 0 may be b. Meanwhile, the critical c may be 10 or less.

For example, in the case in which the deviation |a−b| of the AF code value is 10 or less, the phase difference value extracted from two images acquired from the image that has passed through the mask layer of the image sensor unit may be less than the phase difference value at which focus adjustment can be performed using the phase difference auto-focus adjustment method.

That is, in the case in which the phase difference between the two acquired images is not great and thus focus adjustment is performed using the phase difference auto-focus adjustment method, it may be difficult to find an accurate focus position. As a result, it is not possible to adjust the accurate focus position using only the phase difference auto-focus adjustment method.

Upon determining that the difference between the AF code values is equal to or less than the critical value, i.e. |a−b|≦c, the step of adjusting the at least one lens to the focal distance position may include a step of performing micro focus adjustment using the contrast auto-focus adjustment method.

Upon determining that the difference between the AF code values is greater than the critical value, i.e. |a−b|>c, the step of adjusting the at least one lens to the focal distance position may include a step of moving the optical unit to a first focus position, at which the difference between the AF code values is equal to or less than the critical value, using the phase difference auto-focus adjustment method and a step of performing micro focus adjustment from the first focus position to a second focus position using the contrast auto-focus adjustment method.

That is, the auto-focus adjustment method according to the embodiment may include a step of extracting a phase difference value, which is an offset amount of the focus, using the phase difference auto-focus adjustment method, finding an AF code value corresponding thereto, and moving the lens of the optical unit to a first focus position, which is a rough focus position, and a step of moving the lens of the optical unit to a second focus position, which is an accurate focus position, through micro focus adjustment using the contrast auto-focus adjustment method.

Meanwhile, when the difference between the AF code value corresponding to the extracted phase difference value and the reference AF code value is equal to or less than the critical value, only the focus adjustment step using the contrast auto-focus adjustment method may be included. At this time, the final position of the optical unit moved through the auto-focus adjustment may be an accurate focus position, at which the phase difference value is 0.

After the optical unit is moved through micro focus adjustment, the AF code value at the final position to which the optical unit has been moved may be updated as a new AF code value when the phase difference value is 0 and may be stored in the memory unit.

In the auto-focus adjustment method according to the embodiment, therefore, the AF code value at the final focal distance position in the focused state may be continuously updated and stored in the memory unit, whereby it is possible to improve focusing accuracy irrespective of any change in the state of the driving unit of the camera module. In addition, it is possible to perform accurate focusing within a short time by performing auto-focus adjustment simultaneously using the phase difference auto-focus adjustment method and the contrast auto-focus adjustment method.

Hereinafter, an embodiment of a terminal including the camera module described above will be described. However, the disclosure is not limited thereto.

The camera module according to the embodiment may be disposed at the front surface or the rear surface of the terminal.

For example, the terminal including the camera module according to the embodiment may be a portable terminal. However, the disclosure is not limited thereto. The camera module according to the embodiment may be used in a stationary terminal.

An image of a subject acquired by the camera module of the terminal may be displayed on a display unit of the portable terminal.

The display unit may be a device for displaying an acquired image such that a user can recognize the image. The display unit may be disposed at the front surface of the portable terminal. The display unit may include a liquid crystal display (LCD) or an organic light-emitting diode (OLED). However, the disclosure is not limited thereto.

In addition, an image acquired by the camera module according to the embodiment may be provided so as to be used for other functions of the portable terminal.

Meanwhile, the memory unit included in the camera module according to the embodiment may be replaced by a portion of a memory of the portable terminal. For example, the AF code values may be stored in the memory of the portable terminal.

Since the portable terminal according to the embodiment includes the camera module according to the embodiment, it is possible to accurately and easily adjust focus using the phase difference focus adjustment method and the contrast focus adjustment method. Even when the number of uses of the camera module and the environment in which the camera module is used are changed, it is possible to perform accurate focus adjustment, thereby acquiring a high-quality image.

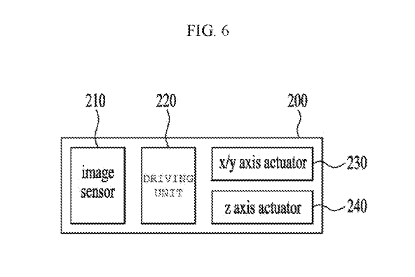

FIG. 6 is a view showing a camera module having an image stabilization function according to another embodiment.

Referring to FIG. 6, a camera module 200 having an image stabilization function according to another embodiment (hereinafter, referred to as a camera module) includes an image sensor 210, a driving unit 220, an x/y-axis actuator 230, and an z-axis actuator 240. Deterioration of an image due to hand shaking during capturing is prevented.

In the embodiment shown in FIG. 6, there are shown only elements necessary to describe the characteristics of the camera module 200. The camera module 200 may be variously configured as needed.

The image sensor 210 is an element that is moved by the actuators 230 and 240 in order to prevent deterioration of an image due to hand shaking irrespective of the term thereof. For example, the image sensor 210 may be a lens or an image sensing element, such as a charge-coupled device (CCD) or a complementary metal-oxide semiconductor (CMOS). The image sensor 210 is moved upward/downward/leftward/rightward to return an image deviated from an optical axis to the original position thereof.

The x/y-axis actuator 230 moves the image sensor 210 along the x axis and the y axis, and the z-axis actuator 240 moves the image sensor 210 along the z axis. The image sensor 210 may include at least one element. That is, an image sensor element for x/y-axis movement and an image sensor element for z-axis movement may be provided separately. In this case, the x/y-axis actuator 230 and the z-axis actuator 240 may be configured to move image sensor elements corresponding thereto.

The driving unit 220 senses hand shaking, and drives the x/y-axis actuator 230 and the z-axis actuator 240 based on the sensing result.

The driving unit 220 does not use a physical sensor, such as a gyro sensor or a hall sensor, in order to sense hand shaking, as in the conventional art, but determines hand shaking based on a left-shield pixel value and a right-shield pixel value and drives the x/y-axis actuator 230 and the z-axis actuator 240 based on the determination result.

A shield pixel is a pixel that is shielded such that a predetermined portion of the pixel cannot sense light.

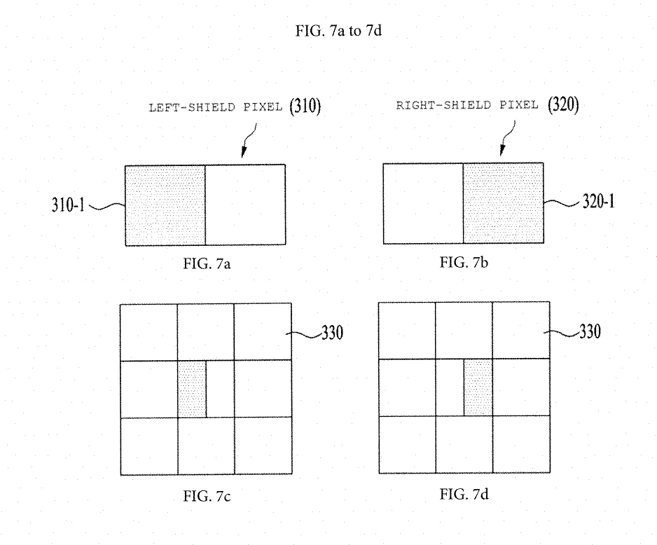

FIG. 7 is a view showing a left-shield pixel and a right-shield pixel.

A pixel having a shielded left part 310-1, as in the example shown in FIG. 7a, is referred to a left-shield pixel 310, and a pixel having a shielded right part 320-1, as in the example shown in FIG. 7b, is referred to a right-shield pixel 320. In addition, a pixel having no shielded part is referred to as a normal pixel.

The size ratio of a shielded part to a shield pixel may be configured variously. For example, if half of a shield pixel is shielded, the amount of light that can be sensed by the shield pixel becomes 50% or less that of a normal pixel, and therefore the probability of the pixel being saturated is reduced to 50% or less.

If a certain pixel is saturated by light, the difference between pixel values cannot be determined, whereby hand shaking may not be detected. In the case in which the probability of a pixel being saturated is reduced thanks to the use of a shield pixel, image stabilization may be achieved.

The number or position of shield pixels may be variously configured as needed.

For example, normal pixels and shield pixels may be alternately arranged in rows, left-shield pixels and right-shield pixels may be alternately arranged in the rows in which the shield pixels are arranged, and the shield pixels may be arranged at random.

A method by which the driving unit 220 senses hand shaking using the shield pixels may be configured variously. In a concrete example, the driving unit 220 may drive the x/y-axis actuator 230 using the difference between left-shield pixel values of the previous frame and the current frame and the difference between right-shield pixel values of the previous frame and the current frame.

That is, when hand shaking occurs, the incidence angle of light is changed, and the amount of light that is sensed by the left-shield pixel and the amount of light that is sensed by the right-shield pixel become different from each other as the incidence angle is changed. Consequently, the magnitude and direction of hand shaking may be determined using the difference between left-shield pixel values of neighboring frames and the difference between right-shield pixel values thereof.

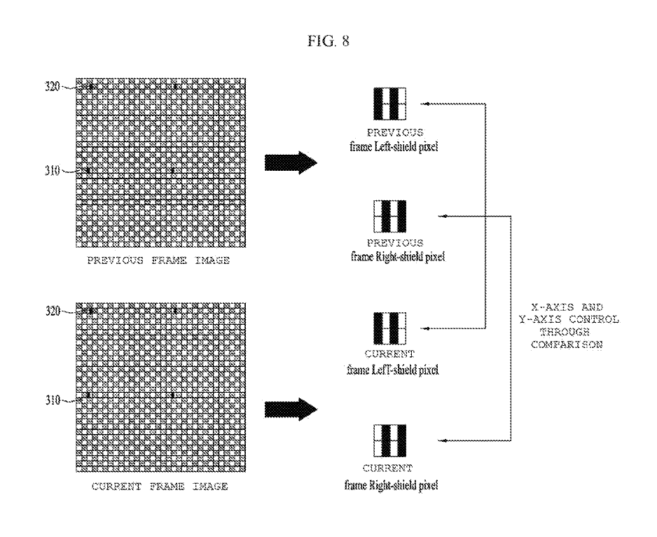

FIG. 8 is a view showing an example in which x/y-axis control is performed using shield pixel values of the previous frame and the current frame.

Referring to FIG. 8, the driving unit 220 compares the value of the left-shield pixel 310 of the previous frame and the value of the left-shield pixel 310 of the current frame with each other and compares the value of the right-shield pixel 320 of the previous frame and the value of the right-shield pixel 320 of the current frame with each other.

The driving unit determines how much the image sensor 210 has to move along the x axis and the y axis, and drives the x/y-axis actuator 230 so as to move the image sensor 210 based on the determined value.

In FIG. 8, there is shown an example in which two right-shield pixels 320 are arranged in the upper row of a frame image and two left-shield pixels 310 are arranged in the middle row of the frame image. As described above, however, the number, position, and arrangement of shield pixels may be variously configured as needed.

The driving unit 220 may drive the x/y-axis actuator 230 and the z-axis actuator 240 using a lookup table.

That is, a movement value based on the difference between the left-shield pixel values of the previous frame and the current frame and a movement value based on the difference between the right-shield pixel values of the previous frame and the current frame are stored in the lookup table in advance, and the x/y-axis actuator 230 may be driven using the movement value corresponding to the sensed hand shaking value.

In another embodiment, the driving unit 220 may sense hand shaking using normal pixels as well as shield pixels. In this case, the driving unit 220 may drive the x/y-axis actuator 230 using the values of a predetermined number of normal pixels located around a left-shield pixel and a right-shield pixel together.

FIG. 7c shows an example in which the values of normal pixels 330 adjacent to a left-shield pixel are used together, and FIG. 7d shows an example in which the values of normal pixels 330 adjacent to a right-shield pixel are used together. A value corresponding to each shield pixel may be calculated using various methods, such as simple addition, simple average, and weighted average of normal pixel values and shield pixel values.

The driving unit 220 drives the x/y-axis actuator 230 using the difference between calculated values corresponding to the shield pixels of the previous frame and the current frame.

In order to perform z-axis control, the driving unit 220 may drive the z-axis actuator 240 based on the phase difference between a left-shield pixel value and a right-shield pixel value of the same frame.

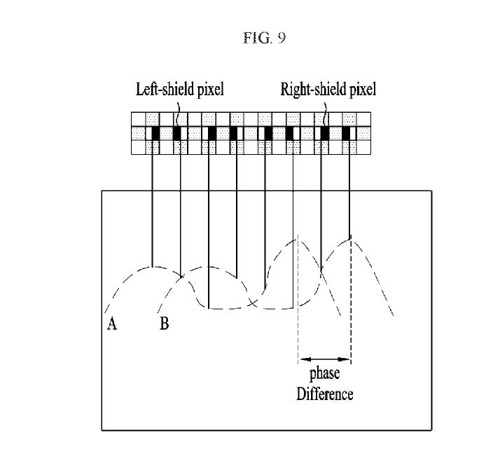

FIG. 9 is a view showing an example in which z-axis control is performed using the phase difference between a left-shield pixel value and a right-shield pixel value.

FIG. 9 shows an example in which right-shield pixels and the left-shield pixels are alternately arranged in a row. The driving unit 220 may calculate a phase A corresponding to each right-shield pixel value and a phase B corresponding to each left-shield pixel value, and may drive the z-axis actuator 240 based on the phase difference to perform z-axis control.

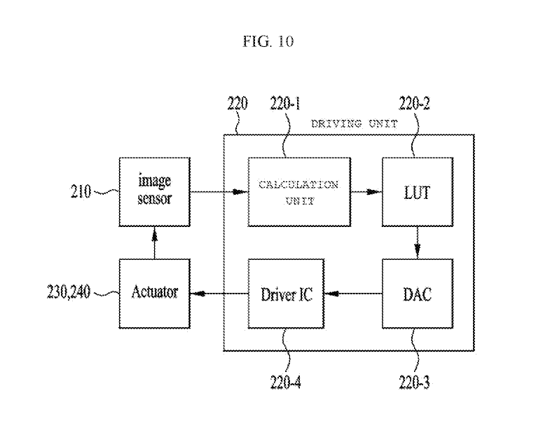

FIG. 10 is a view showing a camera module according to an embodiment.

FIG. 10 shows a concrete embodiment of the driving unit 220 of the camera module 200. The driving unit 220 may include a calculation unit 220-1, a lookup table 220-2, a digital/analog conversion unit 220-3, and a driver integrated circuit (IC) 220-4.

The calculation unit 220-1 calculates a difference value based on x/y-axis movement and a difference value based on z-axis movement using a left-shield pixel value and a right-shield pixel value.

Since both the shield pixel values of the previous frame and the current frame are used for the x/y-axis movement, as previously described, the left-shield pixel value and the right-shield pixel value of the current frame are temporarily stored.

A movement value for moving the image sensor 210 based on each difference value calculated by the calculation unit 220-1 is stored as a digital value in the lookup table 220-2 in advance.

The movement value is converted into an analog signal by the digital/analog conversion unit 220-3, and the analog signal is applied to the driver IC 220-4. The driver IC 220-4 drives the x/y-axis actuator 230 and the z-axis actuator 240 according to the received analog signal to move the image sensor 210, whereby hand shaking compensation is achieved.

Although embodiments have been described with reference to a number of illustrative embodiments thereof, it should be understood that the embodiments are illustrative and not restrictive and that numerous other modifications and applications may be devised by those skilled in the art that will fall within the intrinsic aspects of the embodiments. For example, various variations and modifications are possible in concrete constituent elements of the embodiments. In addition, it is to be understood that differences relevant to the variations and modifications fall within the spirit and scope of the present disclosure defined in the appended claims.

### MODE FOR INVENTION

Various embodiments have been described in the best mode for carrying out the invention.

### INDUSTRIAL APPLICABILITY

A camera module according to embodiments is capable of acquired a high-resolution image. In addition, the structure of the camera module is simplified, whereby manufacturing costs of the camera module are reduced, and the size and weight of the camera module are reduced.

1. A camera module comprising:
an optical unit comprising at least one lens;
an image sensor unit for converting an optical signal acquired by the optical unit into image information;
an image information processing unit for extracting focus adjustment image information from the converted image information;
a memory unit for storing an auto focus (AF) code value;
a controller for retrieving the AF code value corresponding to the focus adjustment image information extracted by the image information processing unit and generating a driving signal for moving the optical unit; and
a driving unit for adjusting a position of the at least one lens according to the driving signal, wherein
the AF code value is updated to an AF code value of a final focused image.

2. The camera module according to claim 1, wherein the focus adjustment image information comprises a phase difference value of the converted image information.

3. The camera module according to claim 1, wherein the driving unit comprises an actuator module for moving the optical unit in an optical-axis direction.

4. The camera module according to claim 1, wherein the controller comprises:
a first AF controller for controlling the optical unit using a phase difference focus adjustment method; and
a second AF controller for controlling the optical unit using a contrast focus adjustment method.

5. The camera module according to claim 1, wherein the image sensor unit comprises:
an optical filter layer comprising a plurality of pick-up pixels;
a shield mask layer comprising a first pixel group having a shield region deviated to one side thereof and a second pixel group having a shield region deviated to the other side thereof; and
a photodiode layer for converting the optical signal that has passed through the optical filter layer and the shield mask layer into an electrical signal.

6. The camera module according to claim 5, wherein each of the pick-up pixels is made up of any one selected from among red (R), green (G), and blue (B) pixels, and the optical filter layer is configured such that the pick-up pixels are arranged so as to neighbor each other in a form of a lattice.

7. The camera module according to claim 5, wherein the first pixel group and the second pixel group have openings, through which light is incident, and shield regions, by which light is blocked.

8. The camera module according to claim 7, wherein the shield region of the first pixel group and the shield region of the second pixel group are symmetric with respect to a vertical line or a horizontal line passing through a center of the pixel.

9. The camera module according to claim 1, wherein the image sensor unit comprises:
an optical filter layer comprising a plurality of pick-up pixels and a plurality of phase difference detection pixels; and
a photodiode layer for converting an optical signal that has passed through the optical filter layer into an electrical signal.

10. The camera module according to claim 1, wherein the memory unit is an electrically erasable programmable read-only memory (EEPROM) or a flash memory.

11. An auto-focus adjustment method comprising:
acquiring optical information;
converting the acquired optical information into an electrical signal;
calculating a phase difference value from the electrical signal;
extracting an AF code value corresponding to the phase difference value;
determining whether a difference between the extracted AF code value and a reference AF code value is equal to or less than a critical value;
moving at least one lens to a focal distance position using at least one selected from between a phase difference auto-focus adjustment method and a contrast auto-focus adjustment method based on the extracted AF code value; and
updating a final AF code value at the focal distance position in a memory unit.

12. The auto-focus adjustment method according to claim 11, wherein, upon determining that the difference between the extracted AF code value and the reference AF code value is equal to or less than the critical value,
the step of moving the at least one lens to the focal distance position comprises performing micro focal distance adjustment using the contrast auto-focus adjustment method.

13. The auto-focus adjustment method according to claim 11, wherein, upon determining that the difference between the extracted AF code value and the reference AF code value is greater than the critical value,
the step of adjusting the at least one lens to the focal distance position comprises:
moving the optical unit to a first focal distance corresponding to the extracted AF code value using the phase difference auto-focus adjustment method; and
performing micro focal distance adjustment from the first focal distance to a second focal distance using the contrast auto-focus adjustment method.

14. A camera module having an image stabilization function comprising:
an image sensor unit;
an x/y-axis actuator for moving the image sensor unit in an x-axis direction and a y-axis direction;
a z-axis actuator for moving the image sensor unit in a z-axis direction; and
a driving unit for driving the x/y-axis actuator and the z-axis actuator, wherein
the driving unit drives the x/y-axis actuator and the z-axis actuator based on a value of a left-shield pixel and a value of a right-shield pixel.

15. The camera module according to claim 14, wherein normal pixels and shield pixels are alternately arranged in rows of a frame, and left-shield pixels and right-shield pixels are alternately arranged in the rows in which the shield pixels are arranged.

16. The camera module according to claim 15, wherein the driving unit drives the x/y-axis actuator using values of a predetermined number of normal pixels located around each left-shield pixel and each right-shield pixel together.

17. The camera module according to claim 14, wherein the driving unit comprises:
a calculation unit for calculating a difference value based on x/y-axis movement and a difference value based on z-axis movement using values of the left-shield pixels and values of the right-shield pixels;
a lookup table for storing a movement value for moving the image sensor unit based on each difference value calculated by the calculation unit as a digital value;
a digital/analog conversion unit for converting the digital value into an analog signal; and
a driver integrated circuit (IC) for driving the x/y-axis actuator and the z-axis actuator according to the analog signal to move the image sensor unit.

18. The camera module according to claim 14, wherein the driving unit drives the x/y-axis actuator using a difference between the left-shield pixel values sensed in a previous frame and a current frame and a difference between the right-shield pixel values of the previous frame and the current frame.

19. The camera module according to claim 18, wherein the driving unit drives the x/y-axis actuator using a lookup table, and the lookup table stores a value for driving the x/y-axis actuator corresponding to the difference between the left-shield pixel values sensed in the previous frame and the current frame and the difference between the right-shield pixel values of the previous frame and the current frame.

20. The camera module according to claim 14, wherein the driving unit drives the z-axis actuator based on a phase difference between the left-shield pixel values and the right-shield pixel values.
